(19) United States
(12) Patent Application Publication
(10) Pub. No.: US 2009/0003890 A1
(43) Pub. Date: Jan. 1, 2009

(54) DEVELOPING UNIT AND AN IMAGE FORMING APPARATUS HAVING THE SAME

(75) Inventors: Jong-woo Lee, Suwon-si (KR); Sung-han Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/956,438

(22) Filed: Dec. 14, 2007

(30) Foreign Application Priority Data
Jun. 29, 2007 (KR) 2007-65351

(51) Int. Cl. G03G 15/08

(52) U.S. Cl. 399/284

(57) ABSTRACT

A developing unit which has an improved structure to limit pressure between a developing member and a regulation roller to a regular range, and an image forming apparatus having the same are provided. A developing unit includes a developing member to develop an electrostatic latent image on a photoconductive medium using a developer, a regulation unit to press toward the developing member to regulate a layer of the developer supplied on the developing member, and a limit unit to limit pressure between the developing member and the regulation unit.

### CROSS-REFERENCE TO RELATED APPLICATIONS

This application claims priority under 35 U.S.C. § 119(a) from Korean Patent Application No. 10-2007-0065351, filed on Jun. 29, 2007, in the Korean Intellectual Property Office, the disclosure of which is incorporated herein by reference in its entirety.

### BACKGROUND OF THE INVENTION

1. Field of the Invention

The present general inventive concept relates to a developing unit to develop an electrostatic latent image, and an image forming apparatus having the same.

2. Description of the Related Art

Image forming apparatuses such as printers, copying machines, facsimile machines, or multifunction device implementing functions of such machines in one device to print images on printing media. Such image forming apparatuses include a feeding unit, a photoconductive medium, a developing unit, a fixing unit, and a discharging unit.

The developing unit develops an electrostatic latent image generated on the photoconductive medium using a developer. The developing unit includes a main body which accommodates a developer, a developing member which is formed in the main body to face the photoconductive medium, a supply roller which supplies a layer of developer to the developing member, and a regulation roller which regulates the layer of developer supplied to the developing member.

The regulation roller is connected and rotated with the developing member by regular pressure with both ends of the regulation roller supported by a pressing member. Thus, the regulation roller regulates the layer of developer on the developing member, and charges the developer on the developing member with electricity generated by friction.

The pressure exerted by the pressing member is a key variable in regulating the developer layer. The quality of images developed on the photoconductive medium depends on the pressure.

If the pressure exerted by the pressing member is less than an optimum level, regulation of a developer and generation of the electric charge by friction using the developing member are not appropriately performed, causing a large amount of developer to be supplied to the developing member.

Furthermore, if a pressing member with high pressure is used, stress on the developer increases, resulting in lower durability and causing material inside the developing member to come off a surface between the developing member and the regulation member over time.

If the main body of the developing device receives an impact due to an external cause, such as dropping the developing device during transport, the pressure member which supports the regulation roller can be spaced apart from the developing member due to momentary inertial force. As a result, developer may escape between the developing member and the regulation roller.

### SUMMARY OF THE INVENTION

The present general inventive concept provides a developing unit which has improved structure to limit pressure between the developing member and the regulation roller to a regular range, and an image forming apparatus having the same.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a developing unit including a developing member to develop an electrostatic latent image on a photoconductive medium using a developer, a regulation unit to press toward the developing member to regulate a layer of the developer supplied on the developing member, and a limit unit to limit pressure between the developing member and the regulation unit.

The developing unit may further include a pressing unit to press at least one end of the regulation unit toward the developing member.

The regulation unit may include a regulation roller to rotate facing the developing member, and at least one pressing unit which presses the regulation roller toward the developing member.

The pressing unit may include a holder to support the regulation roller, and an elastic unit which can be inserted into the holder.

The pressing unit may press an axis of the regulation roller toward the developing member.

The limit unit may limit a compression range of the elastic unit.

The developing unit may further include a supporting plate to support an axis of the developing member and the axis of the regulation roller on a main body of the developing unit, and may include a receiving hole to receive the pressing unit and regulates tension of the elastic unit.

The limit unit may include limit members that are inserted into spaces of the elastic unit, and a limit member body integrally formed with the limit members to support the limit members.

The limit unit can be formed to be selectively separated from the spaces of the elastic unit.

The limit unit can be inserted into the spaces of the elastic member in non-developmental operations.

The limit unit can be fixed on the main body of the developing unit.

The limit unit can be fixed on the supporting plate.

The limit unit can be rotatably formed between a position where the limit unit can be inserted into the spaces of the elastic member and a position where the limit unit escapes from the spaces of the elastic member.

The limit unit can limit a range of compression and stretching of the elastic unit.

The limit unit may include an inserting member to receive the elastic unit and can be inserted into the holder, and a hooking portion to protrude from an outer surface of the inserting member and can be hooked on a hooking groove formed on the main body of the developing unit so as to limit movement of the inserting member.

The hooking portion may include a hooking plate to extend from the outer surface of the inserting member to a predetermined length, and a hook to protrude from the hooking plate to be hooked into the hooking groove.

The inserting member can be shorter than the elastic unit, which is not compressed, so as to compress the elastic unit to a predetermined length when the inserting member can be inserted into the holder.

The foregoing and/or other aspects and utilities of the present general inventive concept may also be achieved by providing an image forming apparatus including a photoconductive medium to generate an electrostatic latent image, and a developing unit to develop the electrostatic latent image using a developer, wherein the developing unit may include a developing member to develop the electrostatic latent image on the photoconductive medium using a developer, a regulation unit pressed toward the developing member to regulate a layer of the developer supplied on the developing member, and a limit unit to limit pressure between the developing member and the regulation unit.

The foregoing and/or other aspects and utilities of the general inventive concept may also be achieved by providing a limiting press unit usable with an image forming apparatus having a developing roller and a regulation roller, the limiting press unit including an elastic unit including an elastic member to provide pressure to elastically press at least one of the developing roller and the regulation roller toward each other, and a plurality of spaces, and a limit unit including a plurality of limit members corresponding to and disposed in the plurality of spaces of the elastic unit, respectively, wherein the limit unit limits the pressure between the developing roller and the regulation unit.

The foregoing and/or other aspects and utilities of the general inventive concept may also be achieved by providing a limiting press unit usable with an image forming apparatus having a developing roller and a regulation roller, the limiting press unit including an inserting member having an inserting groove and at least one hooking member to selectively engage a hooking groove of the image forming apparatus, respectively, a holder having a receiving groove to slidably receive a portion of the inserting member at one end and a roller receiving portion at an other end, and an elastic member disposed in the inserting groove to elastically press at least one of the developing roller and the regulation roller toward each other, wherein an amount of tension and compression of the elastic member are limited by the inserting member being fixed by the at least one hooking portion engaging the respective hooking groove.

### BRIEF DESCRIPTION OF THE DRAWINGS

These and/or other aspects and utilities of the present general inventive will become apparent and more readily appreciated from the following description of the embodiments, taken in conjunction with the accompanying drawings of which:

FIG. 1 is a schematic diagram illustrating a configuration of an image forming apparatus including a developing unit according to an exemplary embodiment of the present general inventive concept;

FIG. 2 is a perspective view illustrating the developing unit from the image forming apparatus of FIG. 1;

FIG. 3 is a perspective view schematically illustrating a limit unit, one of the main portions of a developing unit according to an exemplary embodiment of the present general inventive concept;

FIG. 4 is a perspective view schematically illustrating a transformed exemplary embodiment of the limit unit of FIG. 2;

FIG. 5 is a perspective view schematically illustrating a developing unit according to another exemplary embodiment of the present general inventive concept;

FIGS. 6A and 6B are sectional views illustrating an operation status of the limit unit cut along VI-VI line in FIG. 5; and

FIG. 7 is a perspective view schematically illustrating an insertion member of the limit member of FIG. 5 and an inserted elastic unit.

### DETAILED DESCRIPTION OF THE PREFERRED EMBODIMENTS

Reference will now be made in detail to the present embodiments of the present general inventive concept, examples of which are illustrated in the accompanying drawings, wherein like reference numerals refer to like elements throughout. The embodiments are described below in order to explain the present general inventive concept by referring to the figures.

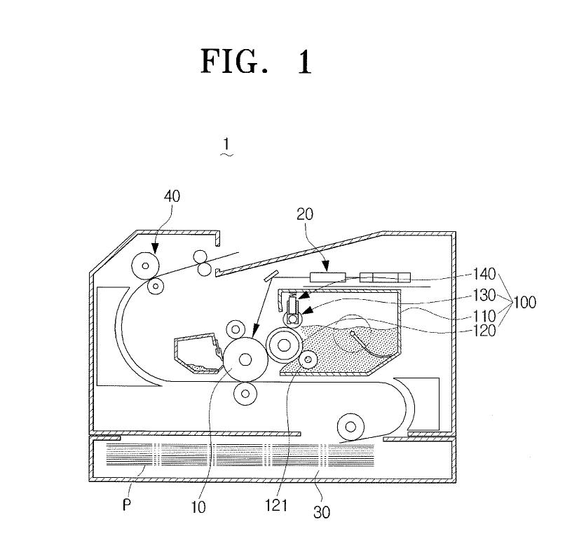

As illustrated in FIG. 1, an image forming apparatus according to an exemplary embodiment of the present general inventive concept includes a photoconductive medium 10 and a developing unit 100.

The photoconductive medium 10 is exposed to light by the light exposure unit 20, and generates an electrostatic latent image on the surface. The photoconductive medium 10 can be a rotatable drum.

The developing unit 100 develops an electrostatic latent image generated on the photoconductive medium 10 using a developer, and includes a main body 110, a developing member 120, a regulation unit 130, and a limit unit 140.

The main body 110 of the developing unit 100 accommodates the developer, and supports a series of elements therein to develop an electrostatic latent image on the photoconductive medium 10, such as the developing member 120, the regulation unit 130, and the limit unit 140.

The developing member 120 can be rotatably mounted on the main body 110 and develops an electrostatic latent image on the photoconductive medium 10 using the developer. Accordingly, the developing member 120 can be formed to face the photoconductive medium 10 and rotate together with the photoconductive medium 10. The developing member 120 receives the developer contained in the main body 110 from a supply roller 121 which can be rotatably formed on the main body 110. A movement of the developer from the developing member 120 to the electrostatic latent image on the photoconductive medium 10 can be caused by a difference in voltage.

The image developed on the photoconductive medium 10 is transferred to a printing medium P fed from the feeding cassette 30, and the printing medium P with the image is fixed by a fixing unit 40 and discharged externally.

The configuration to print an image on a printing medium P is well known in the related art, so a detailed description and drawings are omitted.

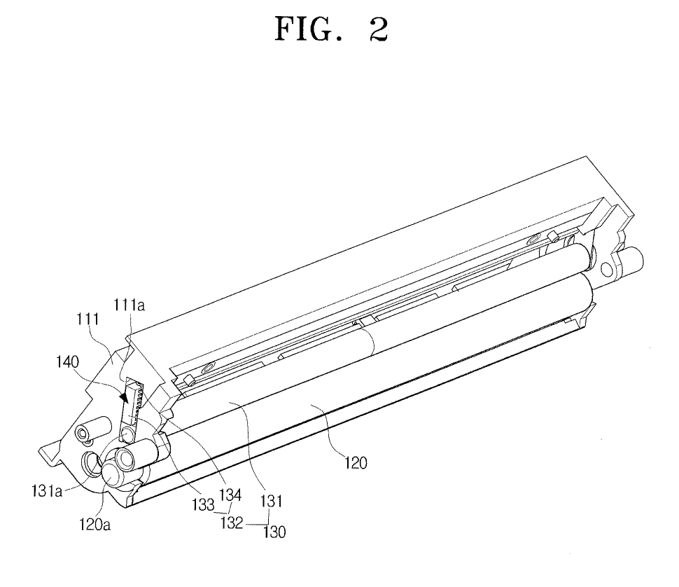

Referring to FIG. 2, the regulation unit 130 regulates a level of a developer layer supplied to the developing member 120, and includes a regulation roller 131 and pressing units 132.

As illustrated in FIG. 2, the regulation roller 131 faces the developing member 120 and rotates together with the developing member 120. With a fixed level of pressure between the developing member 120, the regulation roller 131 regulates the developer layer on the developing member 120. Moreover, the regulation roller 131 contacts the developer on the developing member 120 and electrically charges the developer.

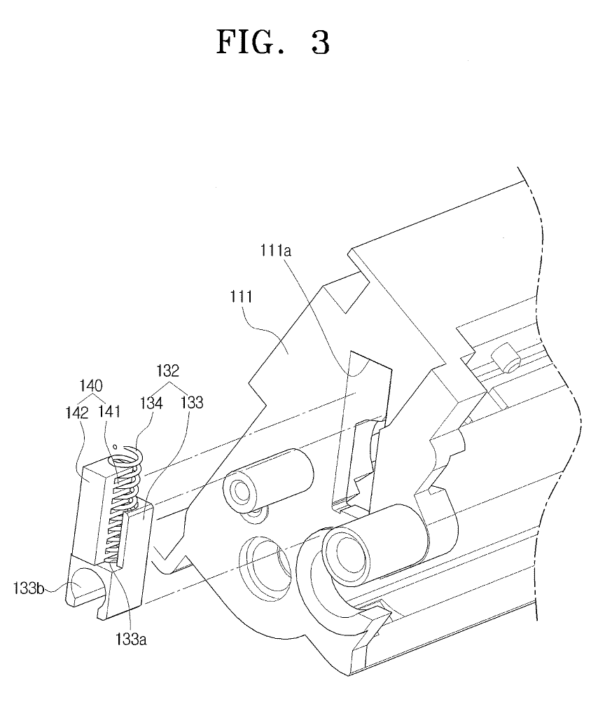

A pair of the pressing units 132 press both ends of the regulation roller 131 toward the developing member 120. As illustrated in FIG. 3, the pressing unit 132 includes a holder 133 and an elastic unit 134.

In the present embodiment, the pressing units 132 are formed on both ends of the regulation roller 131, but a location of the pressing unit 132 is not limited thereto. Alternatively, the pressing unit 132 may be formed on one end of the regulation roller 131.

The holder 133 supports an axis 131a of the regulation roller 131. As illustrated in FIGS. 2 and 3, the holder 133 can be inserted into a receiving hole 111a formed on a supporting plate 111 to support axes 120a and 131a of the developing member 120 and regulation roller 131, respectively, on the main body 110 of the developing unit 100. The holder 133 has an axis hole 133b (FIG. 3) wherein the axis 131a of the regulation roller 131 is inserted.

The elastic unit 134 is inserted into the holder 133 through a receiving groove 133a formed on the holder 133, and can be received in the receiving hole 111a on the supporting plate 111. As a result, tension of the elastic unit 134 is limited by the receiving hole 111a.

The limit unit 140 limits regulation of the developer layer by the regulation unit 130. In this embodiment, compression of the elastic unit 134 is limited. That is, since tension of the elastic unit 134 can be limited by the receiving hole 111a on the supporting plate 111, the limit unit 140 limits compression of the elastic unit 134.

As illustrated in FIG. 3, the limit unit 140 includes a plurality of limit members 141, which are inserted in at least two spaces of the elastic unit 134, and a limit member body 142, which can be integrally formed with the limit members 141 to support the limit members 141.

In the present embodiment, when the image forming apparatus 1 (FIG. 1) is being transported and consequently is not in use, the limit members 141 and the limit member body 142 are inserted into the spaces of the elastic unit 134 without a separate fixing portion. In this case, when the image forming apparatus 1 is in use, a user can be prevented from separating the limit unit 140 from the elastic unit 134 and the limit unit 140 can be prevented from slipping from the elastic unit 134 due to vibration by the operation of the image forming apparatus 1, resulting in damage to other elements.

In this configuration, the limit members 141 limit excessive compression of the elastic unit 134 by inertial force generated by external impact. Therefore, the regulation roller 131 can regulate the layer of developer supplied on the developing member 120.

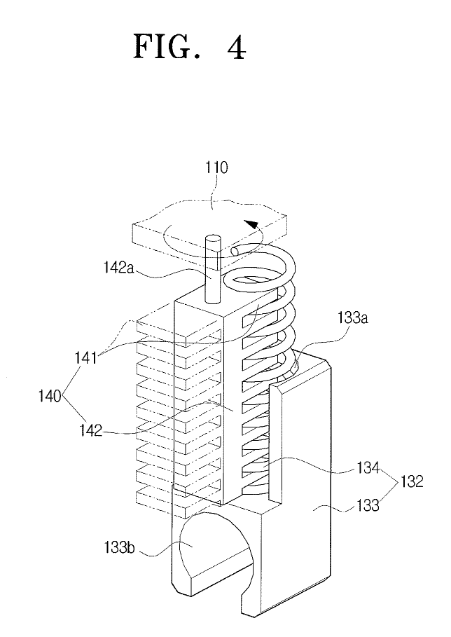

Referring to FIG. 4, the limit unit 140 is not limited to being inserted into the spaces of the elastic unit 134 without a separate fixing portion. The limit unit 140 may rotate on a basis of a rotation axis 142a supported on the main body 110, as illustrated in FIG. 4. In addition, although not illustrated in the drawings, the limit member body 142 may be connected and fixed on the holder 133.

In the above transformed exemplary embodiments of the limit unit 140, as the limit member body 142 can be fixed on the main body 110 or the holder 133, the limit unit 140 can be prevented from separating from the elastic unit 134 while the image forming apparatus 1 (FIG. 1) operates.

Furthermore, this exemplary embodiment illustrates that all of the limit members 141 are inserted into spaces of the elastic unit 134, but the number of the limit members 141 can vary according to a compression range of the limit members 141.

An operation of limiting the pressure of the regulation unit 130 in the developing unit 100 according to an exemplary embodiment and the image forming apparatus having the same is described with reference to FIGS. 2 and 3.

In FIGS. 2 and 3, the regulation roller 131 can be disposed to face the developing member 120 and rotates together with the developing member 120. The axis 120a of the developing member 120 and the axis 131a of the regulation roller 131 are rotatably supported on the supporting plate 111. The axis 131a of the regulation roller 131 can be inserted into the axis hole 133b on the holder 133 of the pressing unit 132.

The elastic unit 134 can be inserted into the holder 133, and the limit members 141 protruding from the limit member body 142 are inserted into the spaces of the elastic unit 134. The holder 133 receiving the elastic unit 134 can be inserted into the receiving hole 111a on the supporting plate 111.

As a result, the tension of the elastic unit 134 can be limited by the receiving hole 111a on the supporting plate 111, and compression of the elastic unit 134 can be limited by the limit members 141 inserted into the spaces. Therefore, the tension and compression of the elastic unit 134 can be maintained initially.

The limit members 141 and the limit member body 142 supporting the limit members 141 can be separated from the elastic unit 134 by a user, during operations not related to image formation, such as transportation of the image forming apparatus 1 (FIG. 1), so that the limit members 141 can be prevented from being separated from the elastic unit 134 and damaging other elements.

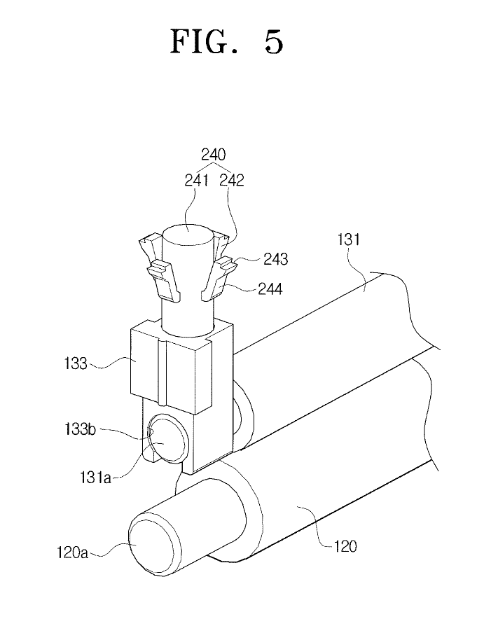

With reference to FIG. 1, an image forming apparatus 1 includes a photoconductive medium 10, a main body 110, a developing member 120, a regulation unit 130, and a limit unit 140, as illustrated in the exemplary embodiment with reference to FIGS. 1 to 4. However, the configuration of the limit unit 240 as illustrated in FIG. 5 can be different from that of the limit unit 140 in the exemplary embodiment described with reference to FIGS. 1 to 4.

Components that are shared in the two exemplary embodiments, such as the photoconductive medium 10, the main body 110, the developing member 120, and the regulation unit 130 are given the same reference numeral, and a detailed description thereof is omitted here.

With reference to FIG. 5, the limit unit 240, which is a feature of the present exemplary embodiment, includes an inserting member 241 and a hooking portion 242.

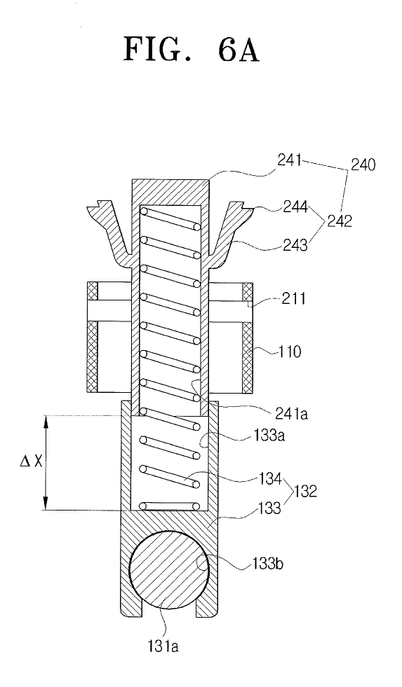

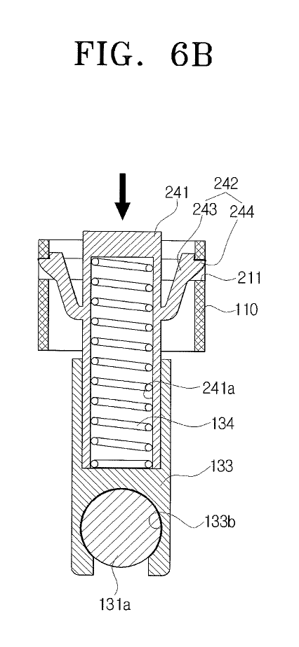

As illustrated in FIG. 6B, the inserting member 241 can be inserted into the holder 133 with the elastic unit 134 received in an inserting groove 241a. An external diameter of the inserting member 241 can be shorter than that of a receiving groove 133a inside the holder 133, so that the inserting member 241 can slide inside the receiving groove 133a of the holder 133. The receiving groove 133a of this exemplary embodiment has a cylindrical shape, and can be open at the top so that the inserting member 241 can be inserted. In contrast to the receiving groove 133a having an open side of the holder 133 as described with reference to FIGS. 1 to 4. That is, the receiving groove 133a of this exemplary embodiment guides the sliding of the inserting member 241.

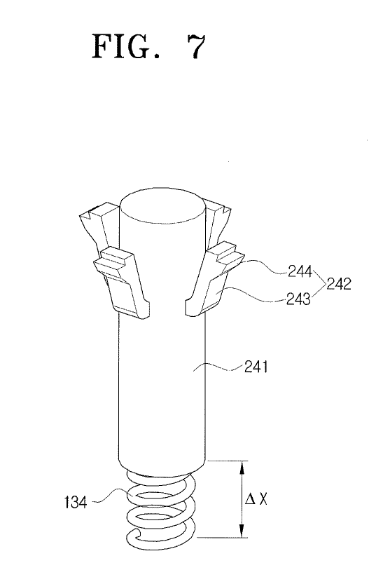

As illustrated in FIGS. 6A and 7, when the inserting member 241 slidably moves inside the holder 133 to a predetermined depth, the elastic unit 134 can be compressed to a predetermined length (Δx) so that the length of the elastic unit 134 can be shorter than prior to the compression.

As illustrated in FIGS. 6A and 7, the hooking portion 242 protrudes from an outer surface of the inserting member 241 to be fixed to a hooking groove 211 formed on the main body 110 of the developing unit 100. The hooking portion 242 includes a hooking plate 243 to extend from the outer surface of the inserting member 241 to a predetermined length, and a hook 244 to protrude from the hooking plate 243 to be hooked on the hooking groove 211 formed on the main body 110 of the developing unit 100. The hooking plate 243 elastically catches the hook 244 on the hooking groove 211 of the main body 110 like a leaf spring, as illustrated in FIG. 6B.

At least two hooking portions 242 may be formed on the outer surface of the inserting member 241. As illustrated in FIG. 7, four hooking portions 242 are formed in this exemplary embodiment.

As illustrated in FIG. 6B, the inserting member 241 can be inserted into the receiving groove 133a of the holder 133 with the elastic unit 134 inserted in the inserting groove 241a, and the elastic unit 134 can be compressed to a predetermined length (Δx). In this state, if the hook 244 of the hooking portion 242 protruding from a circumferential surface of the inserting member 241 is attached to the hooking groove 211 of the main body 110, the hooking force between the hooking groove 211 and the hook 244 can be fixed using the elasticity of the hooking plate 243.

Accordingly, the tension and the compression of the elastic unit 134 are limited by the inserting groove 241a inside the inserting member 241 being fixed on the hooking groove 211 by the hooking portion 242. Consequently, the tension and the compression of the elastic unit 134 can be maintained without being limited by impacts occurring during transportation or by the driving force of the developing unit 100.

In the two exemplary embodiments, the elastic unit 134 is exemplified with a coil spring, but it is not limited thereto. The elastic unit 134 may be one of a variety of stretching/compression units, other than a coil spring such as a leaf spring.

As can be appreciated from the above description, a limit unit limits pressure of a pressing unit between a developing member and regulation roller so that the pressure of the pressing unit can be limited without change in spite of external impacts. Moreover, the limit unit limits compression between the developing member and regulation roller so that regular image quality can be maintained.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A developing unit, comprising:
a developing member to develop an electrostatic latent image on a photoconductive medium using a developer;
a regulation unit to press toward the developing member to regulate a layer of the developer supplied on the developing member; and
a limit unit to limit pressure between the developing member and the regulation unit.

2. The developing unit of claim 1, further comprising:
a pressing unit to press at least one end of the regulation unit toward the developing member.

3. The developing unit of claim 1, wherein the regulation unit comprises:
a regulation roller to rotate facing the developing member; and
at least one pressing unit to press the regulation roller toward the developing member.

4. The developing unit of claim 3, wherein the pressing unit comprises
a holder to support the regulation roller; and
an elastic unit inserted into the holder.

5. The developing unit of claim 4, wherein the pressing unit presses an axis of the regulation roller toward the developing member.

6. The developing unit of claim 5, wherein the limit unit limits the compression range of the elastic unit.

7. The developing unit of claim 6, further comprising:
a supporting plate to support an axis of the developing member and the axis of the regulation roller on a main body of the developing unit, and comprises a receiving hole to receive the pressing unit and to regulate tension of the elastic unit.

8. The developing unit of claim 7, wherein the limit unit comprises:
limit members inserted into spaces of the elastic unit; and
a limit member body integrally formed with the limit members to support the limit members.

9. The developing unit of claim 8, wherein the limit unit is formed to be selectively separated from the spaces of the elastic unit.

10. The developing unit of claim 9, wherein the limit unit is inserted into the spaces of the elastic member in non-developmental operations.

11. The developing unit of claim 8, wherein the limit unit is fixed on one of the main body of the developing unit.

12. The developing unit of claim 8, wherein the limit unit is fixed on the supporting plate.

13. The developing unit of claim 11, wherein the limit unit is rotatably formed between a position where the limit unit is inserted into the spaces of the elastic member and a position where the limit unit escapes from the spaces of the elastic member.

14. The developing unit of claim 4, wherein the limit unit limits a range of compression and stretching of the elastic unit.

15. The developing unit of claim 14, wherein the limit unit comprises
an inserting member to receive the elastic unit and is inserted into the holder; and
a hooking portion to protrude from an outer surface of the inserting member and is hooked on a hooking groove formed on the main body of the developing unit so as to limit movement of the inserting member.

16. The developing unit of claim 15, wherein the hooking portion comprises
a hooking plate to extend from the outer surface of the inserting member to a predetermined length and
a hook to protrude from the hooking plate to be hooked into the hooking groove.

17. The developing unit of claim 15, wherein the inserting member is shorter than the elastic unit, which is not compressed, so as to compress the elastic unit to a predetermined length when the inserting member is inserted into the holder.

18. An image forming apparatus, comprising:
a photoconductive medium to generate an electrostatic latent image; and
a developing unit to develop the electrostatic latent image using a developer, wherein the developing unit comprises:
a developing member to develop the electrostatic latent image on the photoconductive medium using a developer;
a regulation unit pressed toward the developing member to regulate a layer of the developer supplied on the developing member; and
a limit unit to limit pressure between the developing member and the regulation unit.

19. The image forming apparatus of claim 18, further comprising:
a pressing unit to press at least one end of the regulation unit toward the developing member.

20. The image forming apparatus of claim 18, wherein the regulation unit comprises
a regulation roller to rotate facing the developing member and; and
at least one pressing unit to press the regulation roller toward the developing member.

21. The image forming apparatus of claim 20, wherein the pressing unit comprising
a holder to support a regulation roller; and
an elastic unit inserted into the holder.

22. The image forming apparatus of claim 21, wherein the pressing unit presses an axis of the regulation roller toward the developing member.

23. The image forming apparatus of claim 22, wherein the limit unit limits a compression range of the elastic unit.

24. The image forming apparatus of claim 23, further comprising:
a supporting plate to support an axis of the developing member and the axis of the regulation roller on a main body of the developing unit, and comprises a receiving hole to receive the pressing unit and to regulate tension of the elastic unit.

25. The image forming apparatus of claim 24, wherein the limit unit comprises:
limit members inserted into spaces of the elastic unit; and
a limit member body integrally formed with the limit members to support the limit members.

26. The image forming apparatus of claim 25, wherein the limit unit is formed to be selectively separated from the spaces of the elastic unit.

27. The image forming apparatus of claim 26, wherein the limit unit is inserted into the spaces of the elastic member in non-developmental operations.

28. The image forming apparatus of claim 25, wherein the limit unit is fixed on one of the main body of the developing unit.

29. The image forming apparatus of claim 25, wherein the limit unit is fixed on the supporting plate.

30. The image forming apparatus of claim 28,
wherein the limit unit is rotatably formed between a position where the limit unit is inserted into the spaces of the elastic member and a position where the limit unit escapes from the spaces of the elastic member.

31. The image forming apparatus of claim 21, wherein the limit unit limits a range of compression and stretching of the elastic unit.

32. The image forming apparatus of claim 31, wherein the limit unit comprises:
an inserting member to receive the elastic unit and is inserted into the holder; and
a hooking portion to protrude from an outer surface of the inserting member and is hooked on a hooking groove formed on the main body of the developing unit so as to limit movement of the inserting member.

33. The image forming apparatus of claim 32, wherein the hooking portion comprises
a hooking plate to extend from the outer surface of the inserting member to a predetermined length; and
a hook to protrude from the hooking plate to be hooked into the hooking groove.

34. The image forming apparatus of claim 32, wherein the inserting member is shorter than the elastic unit, which is not compressed, so as to compress the elastic unit to a predetermined length when the inserting member is inserted into the holder.

35. A limiting press unit usable with an image forming apparatus having a developing roller and a regulation roller, the limiting press unit comprising:
an elastic unit including an elastic member to provide pressure to elastically press at least one of the developing roller and the regulation roller toward each other, and a plurality of spaces; and
a limit unit including a plurality of limit members corresponding to and disposed in the plurality of spaces of the elastic unit, respectively,
wherein the limit unit limits the pressure between the developing roller and the regulation unit.

36. The limiting press unit of claim 35, wherein the elastic unit further comprises:
a holder to hold the elastic member on one end, to hold one of the developing roller and regulating roller on an other end, and to engage a receiving hole of the image forming apparatus.

37. A limiting press unit usable with an image forming apparatus having a developing roller and a regulation roller, the limiting press unit comprising:
an inserting member having an inserting groove and at least one hooking member to selectively engage a hooking groove of the image forming apparatus, respectively;
a holder having a receiving groove to slidably receive a portion of the inserting member at one end and a roller receiving portion at an other end; and
an elastic member disposed in the inserting groove to elastically press at least one of the developing roller and the regulation roller toward each other;
wherein an amount of tension and a compression of the elastic member are limited by the inserting member being fixed by the at least one hooking portion engaging the respective hooking groove.
